(19) United States
(12) Patent Application Publication
(10) Pub. No.: US 2009/0128650 A1
(43) Pub. Date: May 21, 2009

(54) Imaging Device

(76) Inventors: Kazusei Takahashi, Hyogo (JP); Kiyoshi Takagi, Tokyo (JP); Yoshito Katagiri, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/887,190

(22) PCT Filed: Mar. 7, 2006
(86) PCT No.: PCT/JP2006/304301

§ 371 Date: Sep. 25, 2007

(30) Foreign Application Priority Data
Mar. 29, 2005 (JP) 2005 094432

(51) Int. Cl. H04N 5/228; G06T 11/20

(52) U.S. Cl. 348/222.1; 345/440; 348/333.02; 348/E05.031

(57) ABSTRACT

An imaging device includes: an imaging element which comprises a plurality of pixels capable of switching between a linear conversion operation for linearly converting incident light into an electric signal and a logarithmic conversion operation for logarithmically converting the incident light into an electric signal, according to an incident light quantity; an operation section which is operated for changing an inflection point, the inflection point is a boundary between a linear region and a logarithmic region of output signals of the imaging element; and an inflection point changing section which changes the inflection point of the imaging element according to an operation of the operation unit.

### FIELD OF THE INVENTION

The present invention relates to an imaging device, particularly to an imaging device containing an imaging element that allows switching between a logarithmic conversion operation and a linear conversion operation.

### BACKGROUND

In the conventional art, the imaging device of a camera unit or the like incorporated in a digital camera or on onboard camera has been provided with an photoelectric conversion imaging element for converting incident light into an electric signal. Recent years have witnessed a proposal of an imaging element (linear log sensor) capable of switching between a linear conversion operation and logarithmic conversion operation for electric signal according to the incident light quantity (Patent Documents 1 and 2).

When compared to an imaging element (linear sensor) that performs only the linear conversion operation, such an imaging element is characterized by wider dynamic range, and the entire luminance information can be represented by an electric signals even when a subject having a wide range of luminance has been imaged.

When compared to an imaging element (log sensor) that performs only the logarithmic conversion operation, the aforementioned imaging element avoids the problem wherein an decrease in amount of the data to be outputted, according to the luminance value, even within a predetermined range of luminance, with the result that a sufficient contrast of the subject can be ensured.

The imaging device equipped with a linear log sensor disclosed in the aforementioned Patent Document 1 or 2 is preferably used for imaging by fully utilizing the advantages of each of the linear conversion operation and logarithmic conversion operation of the linear log sensor. To be more specific, when there is a wide range of the luminance of the captured image, the logarithmic conversion region of the imaging element is preferably increased for use. When a sufficient contrast of the subject is desired, the linear conversion region of the imaging element is preferably used in an effective manner. Namely, the boundary point between the linear conversion operation and logarithmic conversion operation should be adequately switched in response to the particular requirement of an subject within the imaging screen.

Under this circumstance, a proposal has been produced in the conventional art. According to this proposal, the linear conversion operation or logarithmic conversion operation of a linear log sensor is employed to ensure that, after the major subject is automatically determined according to a predetermined algorithm, a desired image can be captured.

Patent Document 1: Unexamined Japanese Patent Application Publication No. 2002-223392

Patent Document 2: Unexamined Japanese Patent Application Publication No. 2004-088312

### DISCLOSURE OF INVENTION

### Problems to be Solved by the Invention

An image desired by the user cannot always be obtained even when the image has been captured by using the aforementioned linear long sensor wherein the boundary point between the linear conversion operation and logarithmic conversion operation is automatically switched.

In this case, to get a desired image, the user changes the exposition conditions such as an aperture value, shutter speed and gain, for example, to capture the image. However, it is difficult to keep track of how to change the boundary point in order to get an intended image in a linear long sensor having the functions of both the linear conversion operation and logarithmic conversion operation. Thus, the problem of such poor usability of the imaging device has been left unsolved in the conventional method.

The object of the present invention is to provide an imaging device and imaging method thereof, the imaging device having an imaging element capable of switching between a linear conversion operation and logarithmic conversion operation, in such a way that a desired image can be easily captured by the user who changes the photoelectric conversion characteristics of the linear long sensor.

### Means for Solving the Problems

To solve the aforementioned problem, the invention described in claim 1 provides an imaging device that includes:

an imaging element which comprises a plurality of pixels capable of switching between a linear conversion operation for linearly converting incident light into an electric signal and a logarithmic conversion operation for logarithmically converting the incident light into an electric signal, according to an incident light quantity;

an operation section which is operated for changing an inflection point, the inflection point is a boundary between a linear region and a logarithmic region of output signals of the imaging element; and

an inflection point changing section which changes the inflection point of the imaging element according to an operation of the operation unit.

According to the invention described in claim 1, the user is allowed to set the inflection point as a boundary between the linear conversion operation and logarithmic conversion operation to a desired position through the operation of the operation section. Thus, the user can easily get a desired captured image by changing the photoelectric conversion characteristics of the imaging element.

The invention described in claim 2 provides the imaging device described in claim 1, wherein the imaging device is further includes a monitor which displays the inflection point position gauge provided with an inflection pointer showing a position of the inflection point,

wherein, the operation section is configured to be able to move the inflection pointer on the inflection point position gauge, and the inflection point changing section changes the inflection point in response to a position of the inflection pointer on the inflection point position gauge.

According to the invention described in claim 2, the user is allowed to move the inflection pointer by visually observing the position of the inflection pointer on the inflection point position gauge displayed on the monitor. This procedure allows the user to check the position of the inflection point by his or her own operation. Further, the position of the inflection point can be fine-adjusted by the movement of the inflection pointer.

The invention described in claim 3 provides the imaging device described in claim 2, wherein the monitor displays the inflection point position gauge on a preview screen of a captured image, and displays the preview screen subsequent to a change of the inflection point, in response to the change of the inflection point by the inflection point changing section.

According to the invention described in claim 3, the preview screen subsequent to change of the inflection point is displayed in response to the change of the inflection point by the user's operation. This arrangement allows the user to determine the position of the inflection point through visual observation of how the captured image is changed by his or her own operation.

The invention described in claim 4 provides the imaging device described in claim 1, further including a monitor which displays a graph showing a relationship between an output signal and an incident light quantity to the imaging element, together with an inflection pointer showing a position of the inflection point on the graph,

wherein, the operation section is configured to be able to move the inflection pointer on the graph, and the inflection point changing section changes the inflection point in response to a position of the inflection pointer on the graph.

According to the invention described in claim 4, the user can move the inflection pointer by visually observing the position of the inflection pointer on the graph of the output signal of the imaging element displayed on the monitor. This arrangement allows the user to have a clear idea on how the inflection point is changed by his or her own operation. Especially, the user determines the position of the inflection pointer on the graph of the output signal of the imaging element, and hence, easily gets a clear idea on the change of the photoelectric conversion characteristics. Further, the position of the inflection point can be fine-adjusted by the movement of the inflection pointer.

The invention described in claim 5 provides the imaging device described in claim 4, wherein the monitor displays the graph and the inflection pointer on a preview screen of a captured image, and displays the preview screen subsequent to a change of the inflection point, in response to the change of the inflection point by the inflection point changing section.

According to the invention described in claim 5, the graph of the output signal of the imaging element subsequent to change of the inflection point is displayed in response to the change of the inflection point by the user's operation. This arrangement allows the user to determine the position of the inflection point by visually observing how the photoelectric conversion characteristics of the imaging element are changed by the change of the inflection point. Further, the user can verify how the captured image is changed by his or her own operation.

The invention described in claim 6 provides the imaging device described in claim 1, further including a monitor which displays a histogram of output signal values of the imaging element and a inflection point setting line showing the position of the inflection point on the histogram, wherein, the operation section is configured to be able to move the inflection point setting line on the histogram, and the inflection point changing section changes the inflection point in response to a position of the inflection point setting line on the histogram.

According to the invention described in claim 6, the user is allowed to move the inflection point setting line by visually observing the position of the inflection point setting line on the histogram shown on the monitor. This arrangement allows the user to have a clear idea on how the inflection point is changed by his or her own operation. Further, the position of the inflection point can be fine-adjusted by the movement of the inflection point setting line.

The invention described in claim 7 provides the imaging device described in claim 6, wherein the monitor displays the histogram subsequent to a change of the inflection point, as well as the preview screen subsequent to the change of the inflection point.

According to the invention described in claim 7, the histogram of the output signal of the imaging element subsequent to change of the inflection point is displayed in response to the position of the inflection point setting line by the user's operation. This arrangement allows the user to determine the position of the inflection point by visually observing how the output signal distribution of the imaging element is changed by the change of the inflection point. Further, the preview screen subsequent to change of the inflection point is displayed. This allows the user to verify how the captured image is changed by his or her own operation.

The invention described in claim 8 provides the imaging device described in any one of the claims 1 through 7, wherein the inflection point changing section changes the inflection point by changing a voltage value set on the plurality of pixels of the imaging element.

According to the invention described in claim 8, the inflection point of the output signal of the imaging element can be changed.

### Effects of the Invention

According to the invention described in claim 1, the photoelectric conversion characteristics of the imaging element is changed as intended, by desired setting of the inflection point, whereby a desired captured image can be obtained.

According to the invention described in claim 2, the user is allowed to verify where the inflection point is located by his or her own operation, and to fine-adjust the position of the inflection point by the movement of the inflection pointer. This arrangement easily provides a desired captured image by changing the photoelectric conversion characteristics of the imaging element as desired.

According to the invention described in claim 3, the user can determine the position of the inflection point by visually observing the change of the captured image by his or her own operation on the preview screen. This arrangement makes it possible to change the photoelectric conversion characteristics of the imaging element as desired, and to get a desired captured image easily.

According to the invention described in claim 4, the user is allowed to keep track of the change of the inflection point by visually observing the position of the inflection point on the graph, and to easily keep track of the change of the photoelectric conversion characteristics of the imaging element subsequent to change of the inflection point by determining the position of the inflection pointer on the graph. Further, fine-adjustment of the inflection point can be achieved by the movement of the inflection pointer. Accordingly, a desired captured image can be obtained easily by changing the photoelectric conversion characteristics of the imaging element, as intended.

According to the invention described in claim 5, the user can determine the position of the inflection point by visually observing how the photoelectric conversion characteristics of the imaging element are changed, and to verify change of the captured image by his or her own operation on the preview screen. Thus, a desired captured image can be easily obtained by changing the photoelectric conversion characteristics of the imaging element, as intended.

According to the invention described in claim 6, the user can easily keep track of how the distribution of the output signal value of a subject is changed by his or her own operation by visually observing the histogram subsequent to change of the inflection point.

According to the invention described in claim 7, the user is allowed to determine the position of the inflection point by visually observing how the photoelectric conversion characteristics of the imaging element are changed by the change of the inflection point. The user is also allowed to verify how the captured image is changed by his or her own operation on the preview screen. This arrangement easily provides a desired captured image by changing the photoelectric conversion characteristics of the imaging element as desired.

According to the invention described in claim 8, the user is allowed to change the inflection point of the output signal of the imaging element.

### BRIEF DESCRIPTION OF THE DRAWINGS

FIG. 1 is a front view representing the structure of the imaging device as a first embodiment of the present invention;

FIG. 2 is a rear view representing the structure of the imaging device as a first embodiment of the present invention;

FIG. 3 is a block diagram representing the functional structure of the imaging device as a first embodiment of the present invention;

FIG. 4 is a block diagram representing the structure of the imaging element in the first embodiment of the present invention;

FIG. 5 is a circuit diagram of the structure of the pixels of the imaging element in the first embodiment of the present invention;

FIG. 6 is a time chart showing the operation of the pixels of the imaging element in the first embodiment of the present invention;

FIG. 7 is a chart showing the output with respect to the incident light amount of the imaging element in the first embodiment of the present invention;

FIG. 8 is a diagram showing an example of the display screen of the monitor in the first embodiment of the present invention;

FIG. 9 is a flow chart showing the method of imaging in the first embodiment of the present invention;

FIG. 10 is a diagram showing an example of the display screen on the display section in the second embodiment of the present invention;

FIG. 11 is a flow chart showing the method of imaging in the second embodiment of the present invention;

FIG. 12 is a diagram showing an example of the display screen on the display section in the third embodiment of the present invention; and

FIG. 13 is a flow chart showing the method of imaging in the third embodiment of the present invention.

### LEGEND

1. Imaging device
2. Enclosure
3. Lens unit
4. Imaging unit
5. Exposure section
6. Light control sensor
7. System controller
8. Signal processing section
9. Battery
10. Recording medium
11. Monitor
12. Zoom button W
13. Zoom button T
14. Optical finder
15. Cross-shaped key for selection
16. Release switch
17. Power switch
18. USB terminal
22. Lin-log inflection point changing section 22
27. Amplifier
28. Analog-to-digital converter
29. Black reference correcting section
30. AE evaluation value calculating section
31. WB processing section
32. Color interpolating section
33. Color correcting section
34. Gradation converting section
35. Color space converting section
37. Inflection point position gauge
38. Inflection pointer
39. Inflection point adjusting sub-screen
40. Graph
41. Inflection pointer
42. Inflection point adjusting sub-screen
43. Inflection point position gauge
44. Inflection pointer
45. Histogram

### BEST MODES FOR CARRYING OUT THE INVENTION

### Embodiment 1

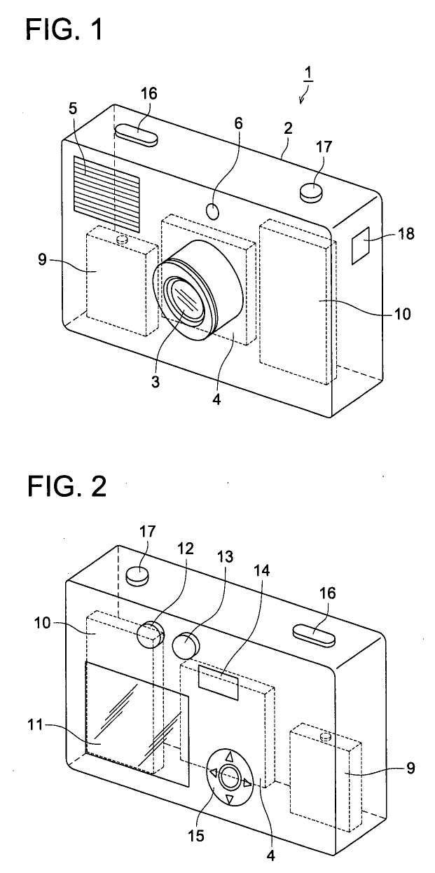

The following describes the first embodiment of the present invention with reference to FIGS. 1 through 9:

The imaging device 1 of the present embodiment is a compact type digital camera. The imaging device of the present invention includes a camera unit incorporated into the electronic equipment such as a mobile phone with camera and onboard camera in addition to the electronic equipment provided with a imaging function such as a single lens digital camera, mobile phone with camera and onboard camera.

As shown in FIG. 1, a lens unit 3 for converging the image light of the subject to a predetermined focus is arranged close to the center on the front of the enclosure 2 of the imaging device 1 in such a way that the optical axis of the lens unit 3 is perpendicular to the front surface of the enclosure 2. An imaging element 4 is arranged inside the enclosure 2 and on the rear of the lens unit 3 so that the light reflected from the subject launched through the lens unit 3 is photoelectrically converting into an electric signal.

An exposure section 5 for applying light at the time of imaging is arranged close to the upper end of the front surface of the enclosure 2. The exposure section 5 of the present embodiment is made of a stroboscope apparatus incorporated in the imaging device 1. It can also be made up of an external stroboscope and a high-luminance LED. Further, a light control sensor 6 is provided on the front surface of the enclosure 2 and close to the upper portion of the lens unit 3. The light applied from the exposure section 5 is reflected from the subject and the reflected light is received by this light control sensor 6.

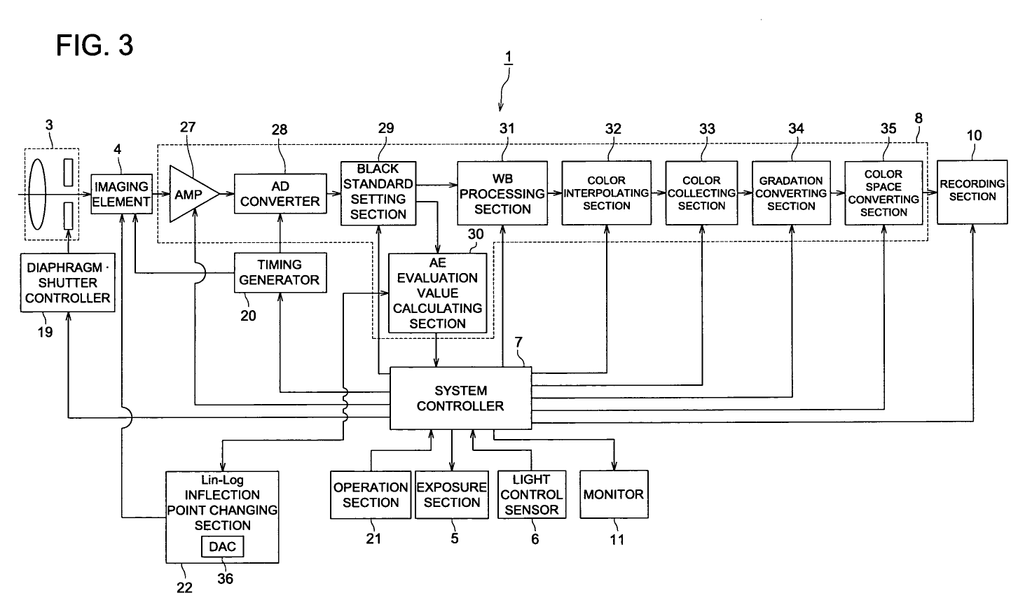

Further, a circuit board (not illustrated) including the circuit such as a system controller 7 and a signal processing section 8 (FIG. 3) is provided inside the enclosure 2 of the imaging device 1. A battery 9 is incorporated inside the enclosure 2, and a recording section 10 such as a memory card is loaded therein.

Further, as shown in FIG. 2, a monitor 11 for image display is arranged on the rear surface of the enclosure 2. The monitor 11 is made up of an LCD (Liquid Crystal Display) and CRT (Cathode Ray Tube) so that the preview screen of the subject and captured image can be displayed.

Further, a zoom button W12 (W: wide angle) for adjusting the zoom and a zoom button T13 (T: telephoto) are provided close to the upper end of the rear surface of the imaging device 1. An optical finder 14 for checking the subject from the rear surface of the enclosure 2 is arranged on the rear surface of the imaging device 1 and above the lens unit 3.

Further, a cross-shaped key for selection 15 is arranged close to the center on the rear surface of the imaging device 1, and is provided with the cross key to move the cursor displayed on the screen of the monitor 11 or the window or to change the specified range of the window. A confirmation key for determining the contents specified by the cursor or window is arranged at the center of the cross-shaped key for selection 15.

A release switch 16 for releasing the shutter is provided on the upper surface of the imaging device 1 and between the battery 9 and lens unit 3. The release switch 16 can be set to two statuses—a halfway pressed status where the switch is pressed halfway and a fully pressed status where the switch is pressed fully.

Further, a power switch 17 is arranged close to the end of the upper surface of the enclosure 2, and is used to turn on or off the power of the imaging device 1 when pressed.

A USB terminal 18 for connecting the USB cable for connection with the personal computer is provided close to the upper end of one side of the enclosure 2.

FIG. 3 shows the functional structure of the imaging device 1.

As described above, the imaging device 1 has a system controller 7 on the circuit board inside the enclosure 2. The system controller 7 includes a CPU (Central Processing Unit), a RAM (Random Access Memory) made up of a rewritable semiconductor element, and a ROM (Read Only Memory) made up of a nonvolatile semiconductor memory.

The system controller 7 is connected with components of the imaging device 1. The system controller 7 ensures that the processing program recorded on the ROM is displayed on the RAM, and this program is executed by the CPU, whereby these components are driven and controlled.

As shown in FIG. 3, the system controller 7 is connected with a lens unit 3, diaphragm/shutter controller 19, imaging element 4, signal processing section 8, timing generating section 20, recording section 10, exposure section 5, light control sensor 6, monitor 11, operation section 21 and lin-log inflection point changing section 22.

The lens unit 3 is made up of a plurality of lenses for forming the optical image of the subject on the image capturing surface of the imaging element 4; an aperture section for adjusting the amount of light converged from the lens; and a shutter section.

The diaphragm/shutter controller 19 controls the drive of the aperture shutter section for adjusting the amount of light converged by the lenses in the lens unit 3. Namely, based on the control value inputted from the system controller 7, the diaphragm/shutter controller 19 sets the aperture to a predetermined aperture value. The shutter is opened immediately before start of the imaging operation of the imaging element 4 and, after the lapse of a predetermined exposure time, the shutter is closed. When the imaging mode is not used, the light entering the imaging element 4 is blocked.

The imaging element 4 photoelectrically converts the incident light of color components of R, G and B as the optical images of the subject into electric signals, which are captured into the system.

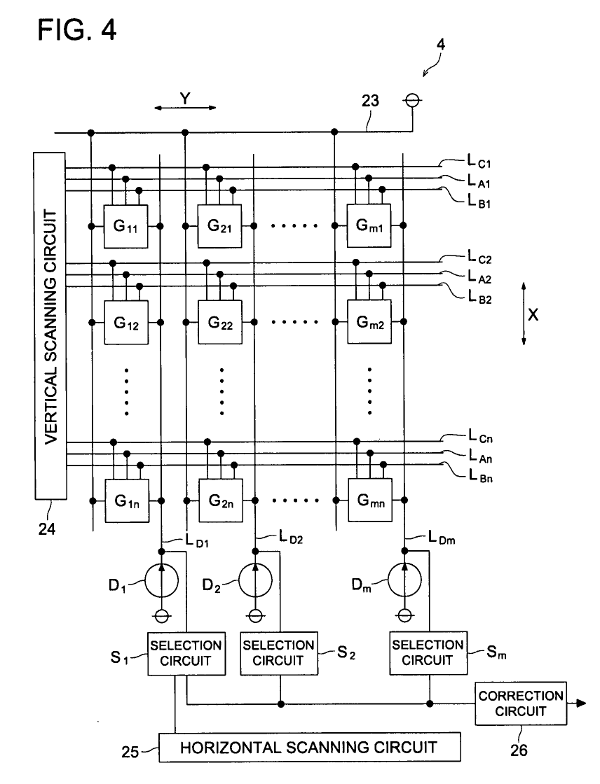

As shown in FIG. 4, the imaging element 4 contains a plurality of pixels G₁₁ through Gₘₙ (where each of n and m is an integer of 1 or more) arranged in a matrix array.

Each of the G₁₁ through Gₘₙ is used to output the electric signal through photoelectric conversion of the incident light. The G₁₁ through Gₘₙ permits switching of the operation of conversion of the electric signal in response to the amount of incident light. To put it in greater details, switching is performed between the linear conversion operation for linearly converting the incident light into an electric signal and the logarithmic conversion operation for logarithmic conversion. In the present embodiment, linear and logarithmic conversion of incident light into electric signal includes conversion into an electric signal wherein the time integral value of the amount of light is linearly changed, and logarithmic conversion into the electric signal wherein logarithmic conversion is performed.

A filter (not illustrated) of any one of the red, green and blue colors is arranged on the side of the lens unit 3 of pixels G₁₁ through Gₘₙ. The pixels G₁₁ through Gₘₙ are connected with the power line 23, signal application lines L_{A1} through L_{An}, L_{B1} through L_{Bn} and L_{C1} through L_{Cn}, and signal read lines L_{D1} through L_{Dn}, as shown in FIG. 4. The pixels G₁₁ through Gₘₙ are also connected with such a line as a clock line and bias supply. They are not shown in FIG. 4.

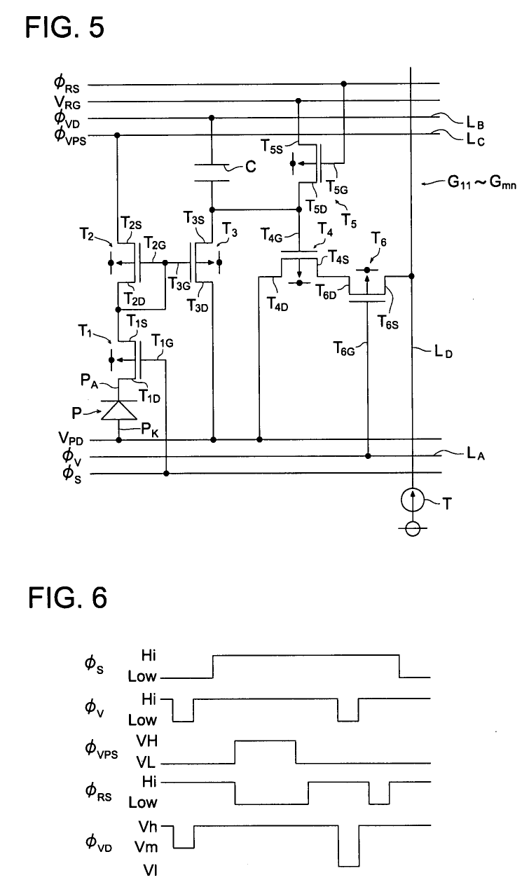

The signal application lines L_{A1} through L_{An}, L_{B1} through L_{Bn} and L_{C1} through L_{Cn} give signals φᵥ, φ_{vD}, φᵥₚₛ (FIGS. 5 and 6) to the pixels G₁₁ through Gₘₙ. The signal application lines L_{A1} through L_{An}, L_{B1} through L_{Bn} and L_{C1} through L_{Cn} are connected with a vertical scanning circuit 24. The vertical scanning circuit 24 applies the signal to the signal application lines L_{A1} through L_{An}, L_{B1} through L_{Bn} and L_{C1} through L_{Cn}, based on the signal from the timing generating section 20 (FIG. 3). Signal application lines L_{A1} through L_{An}, L_{B1} through L_{Bn} and L_{C1} through L_{Cn} for application of signals are sequentially switched in the direction of X.

The electric signal generated by the pixels G₁₁ through Gₘₙ is supplied to the signal read lines L_{D1} through L_{Dm}. The signal read lines L_{D1} through L_{Dm} are connected with constant current sources D₁ through Dₘ and selection circuits S₁ through Sₘ. The DC voltage V_{PS} is applied to one end of the constant current sources D₁ through Dₘ (on the lower end of the drawing).

The selection circuits S₁ through Sₘ are used to sample-hold the noise signal given from the pixels G₁₁ through Gₘₙ through the signal read lines L_{D1} through L_{Dm} and the electric signal at the time of imaging. These selection circuits S₁ through Sₘ are connected with a horizontal scanning circuit 25 and correction circuit 26. The horizontal scanning circuit 25 is used to ensure that the selection circuits S₁ through Sₘ for sample-holding the electric signal and sending it to the correction circuit 26 are sequentially switched in the direction of Y. Further, based on the noise signal sent from the selection circuits S₁ through Sₘ and the electric signal at the time of imaging, the correction circuit 26 removes the noise signal from this electric signal.

The circuits disclosed in the Unexamined Japanese Patent Application Publication No. Hei 2001-223948 can be used as the selection circuits S₁ through Sₘ and correction circuit 26. In the explanation of the present embodiment, only one correction circuit 26 is provided for all the selection circuits S₁ through Sₘ. It is also possible to arrange a correction circuit 26 for each of the selection circuits S₁ through Sₘ.

The following describes the pixels G₁₁ through Gₘₙ with which the imaging element 4 is provided:

As shown in FIG. 5, each of the pixels G₁₁ through Gₘₙ is provided with a photodiode P, transistors T₁ through T₆ and a capacitor C. The transistors T₁ through T₆ are MOS transistors of channel P.

The light having passed through the lens unit 3 is applied to the photodiode P. The DC voltage V_{PD} is applied to the cathode P_{K} of this photodiode P, and the drain T_{1D} of the transistor T₁ is connected to the anode P_{A}.

A signal φ_{S} is inputted to the gate T_{1G} of the transistor T₁, and the gate T_{2G} of the transistor T₂ and the drain T_{2D} are connected to the source T_{IS}.

The source T_{2S} of this transistor T₂ is connected to the signal application lines L_{C} (corresponding to L_{C1} through L_{Cn} of FIG. 4). The signal φᵥₚₛ is inputted through this signal application line L_{C}. As shown in FIG. 6, the signal φᵥₚₛ is a binary voltage signal. To put it in greater details, it assumes two values—a voltage value VL for operating the transistor T₂ in the sub-threshold region when the incident light quantity has exceeded a predetermined incident light quantity and a voltage value VH for activating the transistor T₂.

The source T_{1S} of the transistor T₁ is connected with the gate T_{3G} of the transistor T₃.

The DC current V_{PD} of applied to the drain T_{3D} of the transistor T₃. Further, the source T_{3S} of the transistor T₃ is connected with one end of the capacitor C, the drain T_{5D} of the transistor T₅, and the gate T_{4G} of the transistor T₄.

The other end of the capacitor C is connected with the signal application lines L_{B} (corresponding to L_{B1} through L_{Bn} of FIG. 4). The signal φ_{VD} is supplied from these signal application lines L_{B}. As shown in FIG. 6, the signal φ_{VD} is a ternary voltage signal. To put it in greater details, it assumes three values—a voltage value Vh at the time of integration of the capacitor C, a voltage value Vm at the time of reading the electric signal having been subjected to photoelectric conversion, and a voltage value V1 at the time of reading a noise signal.

The DC voltage V_{RG} is inputted into the source T_{5S} of the transistor T₅, and the signal φ_{RS} is inputted into the gate T_{5G}.

The DC voltage V_{PD} is applied to the drain T_{4D} of the transistor T₄, similarly to the case of the drain T_{3D} of the transistor T₃, and the drain T_{6D} of a transistor T₆ is connected to the source T_{4S}.

The source T_{6S} of a transistor T₆ is connected with the signal read lines L_{D} (corresponding to L_{D1} through L_{Dm} of FIG. 4), and the signal φ_{V} is inputted to the gate T_{6G} from the signal application lines L_{A} (corresponding to L_{A1} through L_{An} of FIG. 4).

Such a circuit configuration allows the pixels G₁₁ through Gₘₙ to be reset as follows:

In the first place, the vertical scanning circuit 24 allows the pixels G₁₁ through Gₘₙ to be reset as shown in FIG. 6.

To put it more specifically, the signal φ_{S} is low, the signal φ_{V} is high, the signal φ_{VPS} is very low, the signal φ_{RS} is high, and the signal φ_{VD} is very high, to start with. From this state, the vertical scanning circuit 24 supplies the pulse signal φ_{V} and the pulse signal φ_{VD} of the voltage value Vm to the pixels G₁₁ through Gₘₙ, then the electric signal is outputted to the signal read line L_{D}. Then the signal φ_{S} goes high and transistor T₁ is turned off.

Then when the vertical scanning circuit 24 allows the signal φ_{VPS} to go very high, the negative charges stored in the gate T_{2G} of the transistor T₂, drain T_{2D} and the gate T_{3G} of the transistor T₃ are quickly coupled again. When the vertical scanning circuit 24 allows the signal φ_{RS} to go low, and the transistor T₅ to be turned on, the voltage at the node for coupling the capacitor C and the gate T_{4G} of the transistor T₄ is initialized.

When the vertical scanning circuit 24 allows the signal φ_{VPS} to go very low, the potential of the transistor T₂ is set back to the original state. After that, the signal φ_{RS} goes high, and the transistor T₅ is turned off. Then the capacitor C performs the process of integration. This arrangement ensures that the voltage at the node for coupling the capacitor C with the gate T_{4G} of the transistor T₄ conforms to the gate voltage of the transistor T₂ having been reset.

Then when the vertical scanning circuit 24 supplies the pulse signal φ_{V} to the gate T_{6G} of the transistor T₆, the transistor T₆ is turned on and the pulse signal φ_{VD} of the voltage value V1 is applied to the capacitor C. In this case, the transistor T₄ acts as a source-follower type MOS transistor, and a noise signal is outputted to the signal read line L_{D} as a voltage signal.

When the vertical scanning circuit 24 supplies the pulse signal φ_{RS} to the gate T_{5G} of the transistor T₅, and the voltage at the node for coupling the capacitor C to the gate T_{4G} of the transistor T₄ is reset. After that, the signal φ_{S} goes low, and the transistor T₁ is turned on. This arrangement terminates the reset operation, and puts the pixels G₁₁ through Gₘₙ ready for imaging.

The pixels G₁₁ through Gₘₙ are designed to perform the following imaging operations:

When the optical charge conforming to the incident light quantity is fed to the transistor T₂ from the photodiode P, the optical charge is stored in the gate T_{2G} of the transistor T₂.

In this case, if the luminance of the subject is low, and the incident light quantity with respect to the photodiode P is smaller than the aforementioned predetermined incident light quantity, then the transistor T₂ is cut off. Accordingly, the voltage conforming to the amount of optical charge stored in the gate T_{2G} of the transistor T₂ appears at this gate T_{2G}. Thus, the voltage resulting from the linear conversion of the incident light appears at the gate T_{3G} Of the transistor T₃.

On the other hand, if the luminance of a subject is high and the incident light quantity is greater than the aforementioned predetermined incident light quantity “th” with respect to the photodiode P, the transistor T₂ operates in the sub-threshold region. Thus, the voltage resulting from the logarithmic conversion of incident light by natural logarithm appears at the gate T_{3G} of the transistor T₃.

It should be noted that, in the present embodiment, the aforementioned predetermined values are the same among the pixels G₁₁ through Gₘₙ.

When the voltage appears at the gate T_{3G} of the transistor T₃, the current flowing to the drain T_{3D} of the transistor T₃ from the capacitor C is amplified in response to the amount of voltage. Thus, the voltage resulting from linear conversion or logarithmic conversion of the incident light of the photodiode P appears at the gate T_{4G} of the transistor T₄.

Then the vertical scanning circuit 24 allows the voltage of the signal φ_{VD} to be Vm, and the signal φ_{V} to go low. Then the source current conforming to the voltage of the gate of the transistor T₄ is fed to the signal read line L_{D} through the transistor T₆. In this case, the transistor T₄ acts as a source-follower type MOS transistor, and the electric signal at the time of imaging appears at the signal read line L_{D} as a voltage signal. In this case, the signal value of the electric signal outputted through the transistors T₄ and T₆ is proportional to the gate voltage of the transistor T₄, so this signal value is the value resulting from the linear conversion or logarithmic conversion of the incident light of the photodiode P.

When the vertical scanning circuit 24 ensures that the voltage value of the signal φ_{VD} goes very high, and the signal φ_{V} goes high, the imaging operation terminates.

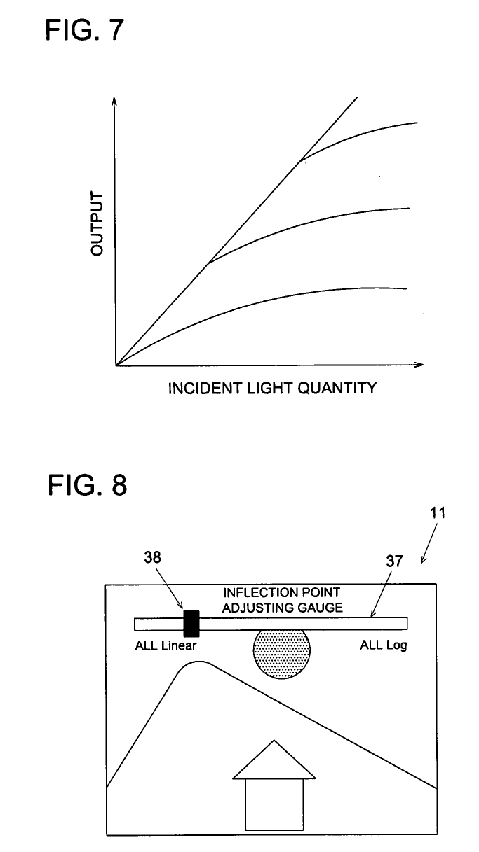

During the operation according to the aforementioned procedure, the voltage value VL of the signal φ_{VPS} goes low at the time of imaging. As the difference from the voltage value VH of the signal φ_{VPS} at the time of resetting is increased, the potential difference between the gate and source of the transistor T₂ is increased. This increases the percentage of the subject luminance wherein the transistor T₂ operates in the cut-off state. Accordingly, as shown in FIG. 7, a lower voltage value VL increases the percentage of the subject luminance having undergone linear conversion. As described above, the output signal of the imaging element 4 of the present embodiment continuously changes from the linear region to the logarithmic region in conformity to the incident light quantity.

Thus, if the subject luminance lies in a narrow range, the voltage value VL is decreased to increase the range of luminance for linear conversion; and if the subject luminance lies in a wide range, the voltage value VL is increased to increase the range of luminance for logarithmic conversion. This arrangement provides the photoelectric conversion characteristics conforming to the characteristics of the subject. It is also possible to arrange such a configuration that, whenever the voltage value VL is minimized, linear conversion mode is set; whereas, whenever the voltage value VH is maximized, logarithmic conversion mode is set.

The dynamic range can be changed over by switching the voltage value VL of the signal φ_{VPS} applied to the pixels G₁₁ through Gₘₙ of the imaging element 4 operating in the aforementioned manner. Namely, when the system control section 2 switches the voltage value VL of the signal φ_{VPS}, it is possible to change the inflection point wherein the linear conversion operation of the pixels G₁₁ through Gₘₙ is switched to the logarithmic conversion operation.

The imaging element 4 of the present embodiment is only required to automatically switch between the linear conversion operation and logarithmic conversion operation in each pixel. The imaging element 4 may be provided with pixels having a structure different from that of FIG. 5.

In the present embodiment, switching between the linear conversion operation and logarithmic conversion operation is achieved by changing the voltage value VL of the signal φ_{VPS} at the time of imaging. It is also possible to arrange such a configuration that the inflection point between the linear conversion operation and logarithmic conversion operation is changed by changing the voltage value VH of the signal φ_{VPS} at the time of resetting. Further, the inflection point between the linear conversion operation and logarithmic conversion operation can be changed by changing the reset time.

Further, the imaging element 4 of the present embodiment is provided with the RGB filters for each pixel. It is also possible to arrange such a configuration that it is provided with other color filters such as cyan, magenta and yellow.

Going back to FIG. 3, the signal processing section 8 includes an amplifier 27, analog-to-digital converter 28, black reference correcting section 29, AE evaluation value calculating section 30, WB processing section 31, color interpolating section 32, color correcting section 33, gradation converting section 34 and color space converting section 35.

Of these, the amplifier 27 amplifies the electric signal outputted from the imaging element 4 to a predetermined level to make up for the insufficient level of the captured image.

The analog-to-digital converter 28 (ADC) ensures that the electric signal amplified in the amplifier 27 is converted from the analog signal to the digital signal.

The black reference correcting section 29 corrects the black level as the minimum luminance value to conform to the standard value. To be more specific, the black level differs according to the dynamic range of the imaging element 4. Accordingly, the signal level as the black level is subtracted from the signal level of each of the R, G and B signals outputted from the analog-to-digital converter 28, whereby the black reference correction is performed.

The AE evaluation value calculating section 30 detects the evaluation value required for the AE (automatic exposure) from the electric signal subsequent to correction of the black reference. To be more specific, the average value distribution range of the luminance is calculated by checking the luminance value of the electric signal made up of the color components of R, G and B, and this value is outputted to the system controller 7 as the AE evaluation value for setting the incident light quantity.

Further, by calculating the correction coefficient from the electric signal subsequent to black reference correction, the WB processing section 31 adjusts the level ratio (R/G, B/G) of the components R, G and B in the captured image, thereby ensuring correct display of white.

When the signal obtained in the pixel of the imaging element 4 is related to one or two out of primary colors, the color interpolating section 32 provides color interpolation for interpolating the missing color components for each pixel so as to obtain the values for the components R, G and B for each pixel.

The color correcting section 33 corrects the color component value for each pixel of the image data inputted from the color interpolating section 32, and generates the image wherein the tone of color of each pixel is enhanced.

In order to achieve the ideal gradation reproduction property from the input of the image to the final output wherein the gamma assumes the value of 1 to reproduce the image faithfully, the gradation converting section 34 provides gamma correction so that the responsive character of the image gradation is corrected to have the optimum curve conforming to the gamma value of the imaging device 1.

The color space converting section 35 changes the color space from the RGB to the YUV. The YUV is a color space management method for representing colors using the luminance (Y) signal and two chromaticities of blue color difference (U, Cb) and red color difference (V, Cr). Data compression of color difference signal alone is facilitated by converting the color space into the YUV.

The timing generating section 20 controls the imaging operation (charge storage and reading of the stored charges based on exposure) by the imaging element 4. To be more specific, based on the imaging control signal from the system controller 7, the timing generating section 20 generates a predetermined timing pulse (pixel drive signal, horizontal sync signal, vertical sync signal, horizontal scanning circuit drive signal, vertical scanning circuit drive signal, etc.), and outputs it to the imaging element 4. Further, the timing generating section 20 also generates the analog-to-digital conversion clock used in the analog-to-digital converter 28.

The recording section 10 is a recording memory made of a semiconductor memory or the like, and contains the image data recording region for recording the image data inputted from the signal processing section 8. The recording section 10 can be a build-in memory such as a flash memory, a detachable memory card or a memory stick, for example. Further, it can be a magnetic recording medium such as a hard disk.

If the luminance of the surrounding environment detected at the time of imaging of the subject is insufficient, the stroboscope as an exposure section 5 applies a predetermined amount of light to the subject at a predetermined exposure timing under the control of the system controller 7.

To adjust the amount of the light applied from the exposure section 5, the light control sensor 6 detects the amount of light which is applied from the exposure section 5 and is reflected from the subject, and the result of detection is outputted to the system controller 7.

The monitor 11 performs the function of a display section. It show the preview screen of a subject, and displays the captured image having been processed on the signal processing section 8, based on the control of the system controller 7. At the same time, the monitor 11 displays the text screen such as the menu screen for the user to select functions. To be more specific, the monitor 11 shows an imaging mode selection screen for selecting the still image capturing mode or moving image capturing mode, and a stroboscope mode selection screen for selecting one of the automatic operation mode, off mode and on mode.

When the “inflection point adjustment imaging mode” has been selected as an imaging mode, the monitor 11 shows the inflection point position gauge 37 on the preview screen, as shown in FIG. 8. The inflection point position gauge 37 displays the position where the inflection point as the boundary between the linear region and logarithmic region of the output signal of the imaging element 4 is currently located according to the position of the inflection pointer 38 in the inflection point position gauge 37. The inflection point position gauge 37 also determines the inflection point by the movement of the inflection pointer 38.

The operation section 21 includes a zoom button W12, zoom button T13, cross-shaped key for selection 15, release switch 16 and power switch 17. When the user operates the operation section 21, the instruction signal corresponding to the function of the button and switch is sent to the system controller 7, and the components of the imaging device 1 are driven and controlled according to the instruction signal.

Of these, the cross-shaped key for selection 15 performs the function of moving the cursor and window on the screen of the monitor 11, when pressed. It also performs the function of determining the contents selected by the cursor or window when the confirmation key at the center is pressed.

To be more specific, when the cross-shaped key for selection 15 is pressed, the cursor displayed on the monitor 11 is moved, and the imaging mode selection screen is opened from the menu screen. Further, the cursor is moved to a desired imaging mode button on the imaging mode selection screen. When the confirmation key is pressed, the imaging mode can be determined.

When the cross-shaped key for selection 15 is pressed on the “inflection point adjustment imaging mode” preview screen, the inflection pointer 38 of the inflection point position gauge 37 displayed on the monitor 11 is moved in the lateral direction, whereby the inflection point is determined. As described above, the user can make fine adjustment of the position of the inflection point by operating the cross-shaped key for selection 15.

In FIG. 8, the percentage of the linear region in the output signal of the imaging element 4 is increased as the inflection pointer 38 of the inflection point position gauge 37 is moved to the left facing the screen. Thus, a 100% linear region will result if it is moved to the leftmost position—to the position of ALL LINEAR in this drawing. In the meantime, the percentage of the logarithmic region in the output signal of the imaging element 4 is increased as the inflection pointer 38 of the inflection point position gauge 37 is moved to the right facing the screen. Thus, a 100% logarithmic region will result if it is moved to the rightmost position—to the position of ALL LOG in this drawing.

When the zoom button W12 is pressed, the zoom is adjusted to reduce the size of the subject. When the zoom button T13 is pressed, the zoom is adjusted to increase the size of the subject.

Further, preparation for imaging starts when the release switch 16 is pressed halfway in the still image imaging mode. When the release switch 16 is pressed fully in the still image imaging mode, a series of imaging operation is performed. Namely, the imaging element 4 is exposed to light, and predetermined processing is applied to the electric signal obtained by the exposure. The result is stored in the recording section 10.

The on/off operations of the imaging device 1 are repeated by pressing the power switch 17.

When the position of the inflection pointer 38 of the inflection point position gauge 37 has been determined on the preview screen of the monitor 11 in the “inflection point adjustment imaging mode”, the lin-log inflection point changing section 22 calculates the voltage value VL to be set on the imaging element 4 in order to change the inflection point conforming to that position.

As described above, when the voltage value VL of the signal φ_{VPS} to be supplied to the pixels G₁₁ through Gₘₙ has been switched, the imaging element 4 of the present invention changes the inflection point for switching from the linear conversion operation to the logarithmic conversion operation.

The output signal of the imaging element 4 is characterized in such a way that, the lower the voltage value VL is, greater will be the percentage of the linear conversion range out of the outputs from the imaging element. Thus, the voltage value VL should be increased when the inflection point is decreased—when the percentage of the linear conversion region is decreased. The voltage value VL should be decreased when the inflection point is increased—when the percentage of the linear conversion region is increased. In this manner, in order to optimize the inflection point of the imaging element 4, the lin-log inflection point changing section 22 calculates the voltage value VL of the signal φ_{VPS} to be supplied to the pixels G₁₁ through Gₘₙ.

It is also possible to arrange such a configuration that the position of the inflection pointer 38 of the inflection point position gauge 37 is associated with the voltage value VL, and a LUT is created in advance. This LUT is stored in the lin-log inflection point changing section 22, and is used to calculate the voltage value VL.

Further, the lin-log inflection point changing section 22 has a digital-to-analog converter 36. The calculated voltage value VL is converted into the analog data, which is inputted into the pixels G₁₁ through Gₘₙ of the imaging element 4, whereby the inflection point of the imaging element 4 is optimized.

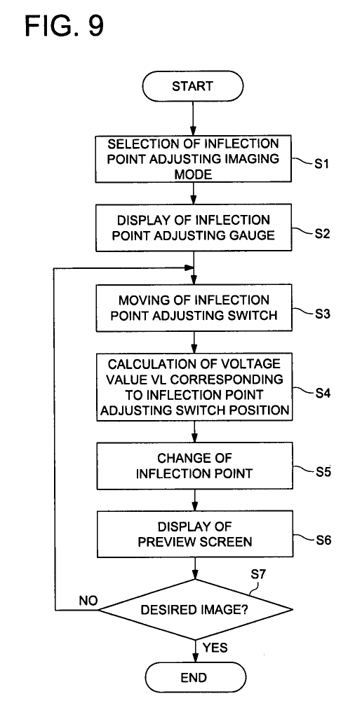

Referring to the flow chart of FIG. 9, the following describes the approximate operation of the imaging device 1 of the present embodiment:

When the power switch 17 of the imaging device 1 is pressed to turn on the power of the imaging device 1, the preview screen of the subject appears on the monitor.

Pressing the zoom button W12 or zoom button T13 arranged on the rear surface of the imaging device 1, the user is allowed to zoom the lens unit 3 to adjust the size of the subject to be displayed on the monitor 11.

When the power is turned on, the imaging mode selection screen appears on the monitor 11. The imaging mode selection screen allows selection between the still imaging image capturing mode and the moving image capturing mode. The “inflection point adjustment imaging mode” is selected by operating the cross-shaped key for selection 15 on the imaging mode selection screen, and the confirmation key at the center is pressed. Then the imaging device 1 enters the inflection point adjustment imaging mode, and the system goes to the display process (Step S1). Then the inflection point position gauge 37 appears on the preview screen of the monitor 11, as shown in FIG. 8 (Step S2).

Then the user operates the cross-shaped key for selection 15 to move the inflection pointer 38 of the inflection point position gauge 37 in the lateral direction on the preview screen and to determine the position of the inflection point (Step S3). In this case, the user is allowed to make fine adjustment of the inflection point by operating the cross-shaped key for selection 15.

In FIG. 8, the percentage of the linear region in the output signal of the imaging element 4 is increased as the inflection pointer 38 of the inflection point position gauge 37 is moved to the left facing the screen. Thus, a 100% linear region will result if it is moved to the leftmost position—to the position of ALL LINEAR in this drawing. In the meantime, the percentage of the logarithmic region in the output signal of the imaging element 4 is increased as the inflection pointer 38 of the inflection point position gauge 37 is moved to the right facing the screen. Thus, a 100% logarithmic region will result if it is moved to the rightmost position—to the position of ALL LOG in this drawing.

The lin-log inflection point changing section 22 goes to the process of changing the inflection point. When the position of the inflection pointer 38 of the inflection point position gauge 37 is determined on the preview screen of the monitor 11 in the “inflection point adjustment imaging mode”, the lin-log inflection point changing section 22 calculates the voltage value VL to be set on the imaging element 4 in order to change the inflection point in conformity to that position (Step S4).

It is also possible to arrange such a configuration that the position of the inflection pointer 38 of the inflection point position gauge 37 is associated with the voltage value VL, and a LUT is created in advance. This LUT is used to get the voltage value VL.

The digital-to-analog converter 36 of the lin-log inflection point changing section 22 converts the calculated voltage value VL into analog data, which is inputted into the pixels G₁₁ through Gₘₙ of the imaging element 4, whereby the inflection point of the imaging element 4 is changed (Step S5).

After that, the monitor 11 shows the preview screen subsequent to the change of the inflection point (Step S6).

As described above, the user is allowed to move the inflection pointer 38 of the inflection point position gauge 37 on the preview screen of the monitor 11 by operating the cross-shaped key for selection 15. While moving it, the user visually observes the captured image subsequent to change of the inflection point on the preview screen, and checks if a desired captured image can be obtained or not (Step S7). If it has been determined that the desired captured image cannot be obtained (NO in Step S7), the system goes back to the Step S3, and the user moves the inflection pointer 38 of the inflection point position gauge 37, whereby a new inflection point can be determined.

When it has been checked that the captured image can be obtained by the change of the inflection point on the preview screen of the monitor 11 (YES in Step S7), the user pressed the release switch 16 halfway. The AF operation as a preparatory step for imaging is performed and an AE evaluation value is calculated. If the release switch 16 is not pressed, the preview screen subsequent to change of the inflection point appears on the monitor 11. This status is kept unchanged.

When the user has pressed the release switch 16 fully, imaging operation starts.

Based on the AE evaluation value calculated by the AE evaluation value calculating section 30 the diaphragm/shutter controller 19 controls the diaphragm and shutter so that the imaging element 4 is exposed to light. Then the pixels G₁₁ through Gₘₙ of the imaging element 4 allow the incident light to undergo photoelectric conversion by switching between the linear conversion operation and logarithmic conversion operation at the inflection point determined by the lin-log inflection point changing section 22. The electric signal obtained by photoelectric conversion is outputted to the signal processing section 8.

The signal processing section 8 applies a predetermined image processing to the electric signal obtained by photoelectric conversion. To be more specific, when the electric signal outputted from the imaging element 4 is amplified to a predetermined level by the amplifier 27, the amplified electric signal is converted into a digital signal by the analog-to-digital converter 28.

Then the black level wherein the luminance is minimized is corrected to the standard value by the black reference correcting section 29. The AE evaluation value calculating section 30 detects the evaluation value required for AE (automatic exposure) from the electric signal subsequent to black reference correction, and sends it to the system controller 7. In the meantime, the WB processing section 31 calculates the correction coefficient from the electric signal subsequent to black reference correction, whereby the level ratio (R/G, B/G) of the components R, G and B is adjusted to ensure correct display of white.

The color interpolating section 32 applies a process of color interpolation wherein the missing component is interpolated for each pixel. The color correcting section 33 corrects the color component value for each pixel, and generates the image wherein the tone of color of each pixel is enhanced. When the gradation converting section 34 has applied the process of gamma correction wherein the response characteristic of the gradation of an image is corrected to have the optimum curve conforming to the gamma value of the imaging device 1, the color space converting section 35 converts the color space from the RGB to the YUV.

The image data outputted from the signal processing section 8 is recorded in the recording section 10.

When the image data recorded in the recording section 10 is to be read into the personal computer or the like, the USB cable linked to the USB terminal 18 is connected to the personal computer.

According to the present embodiment, the user is allowed to freely set the inflection point as a boundary between the linear and logarithmic regions by operating the operation section. Thus, the user can easily get a desired captured image by changing the photoelectric conversion characteristic of the imaging element.

To be more specific, the user is allowed to move the inflection pointer 38 by visually observing it in the inflection point position gauge 37 displayed on the monitor 11. This procedure allows the user to check the position of the inflection point by his or her own operation. Further, the user can make fine adjustment of the position of the inflection point by moving the inflection pointer.

When the inflection point by the user's operation has been changed, the preview screen subsequent to change of the inflection point appears on the monitor 11. The user can determine the position of the inflection point by visually observing how the captured image is changed by his or her own operation.

In the present embodiment, the inflection point position gauge 37 is displayed on the screen of the monitor 11. It is also possible to make such arrangements that the enclosure 2 of the imaging device 1 is provided with an adjusting switch for adjusting the inflection point, and the lin-log inflection point changing section 22 changes the inflection point in response to the operation of this adjusting switch. Further, a zoom button W12 and zoom button T13 can be provided to move the inflection pointer.

In the present embodiment, the inflection point is continuously moved by the movement of the inflection pointer 38 in the inflection point position gauge 37. It is also possible to arrange such a configuration that the inflection point position gauge 37 is divided into a plurality of steps and the inflection point is changed stepwise by the movement of the inflection pointer 38.

Further, it is also possible to make such arrangements that the monitor 11 is divided into a plurality of display screens and, while the preview screen prior to change of the inflection point is kept displayed one of the screens, the preview screen subsequent to change of the inflection point is displayed on the other screen.

The following arrangement can also be used: Together with the information on the aperture value and luminance value, the “linear log ratio” showing the ratio between the linear and logarithmic regions in the output signal of the imaging element 4 is stored on the recording section 10 as the captured image information in the imaging mode, so that the “linear log ratio” can be used in the subsequent imaging operation. In this case, it is also possible to make such arrangements that, for example, if the user has selected the thumbnail image displayed on the monitor 11, the linear log ratio of the selected thumbnail image is read from the recording section 10, and the inflection point corresponding to that linear log ratio is automatically set. This arrangement allows the user to set the optimum inflection point merely by selecting the thumbnail image, with the result that a further convenience is provided.

### Embodiment 2

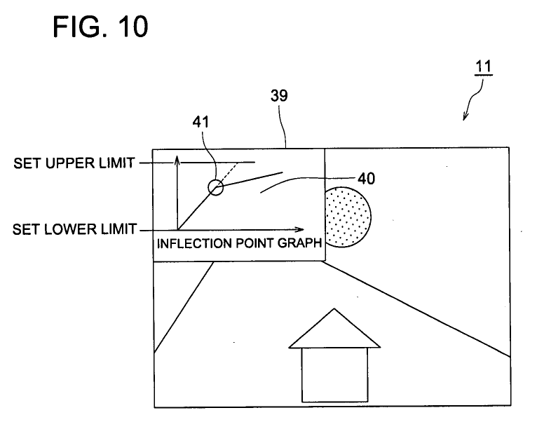

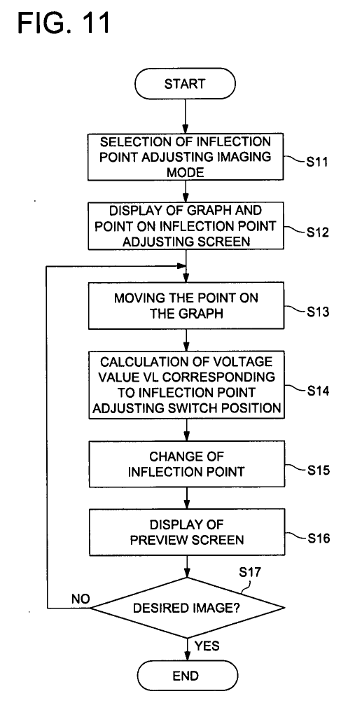

Referring to FIGS. 10 and 11, the following describes the second embodiment of the present invention: It should be noted that the same portions as the aforementioned first embodiment will be assigned with the same numerals of reference, and will not be described to avoid duplication. Only the arrangements different from those of the first embodiment will be described.

When the “inflection point adjustment imaging mode” is selected as the imaging mode, the monitor 11 of the present invention allows the inflection point adjusting sub-screen 39 to be shown on the preview screen, as shown in FIG. 10.

A graph that schematically represents the output signal of the imaging element 4 is displayed on the inflection point adjusting sub-screen 39, to ensure that the user can intuitively keep track of the inflection point as the boundary between the linear region and logarithmic region in the output signal of the imaging element 4. In this graph 40, the inflection point as the boundary between the linear region and logarithmic region is represented by an inflection pointer 41, and the inflection point can be changed by moving the inflection pointer 41.

The cross-shaped key for selection 15 of the operation section 21 in the present embodiment is designed in such a way that the inflection pointer 41 of the graph 40 displayed on the inflection point adjusting sub-screen 39 can be moved by pressing the cross-shaped key in the “inflection point adjustment imaging mode”. The inflection point can be changed when the inflection pointer 41 is moved above the straight line of the linear region. Thus, the user is allowed to make fine adjustment of the inflection point by operating the cross-shaped key for selection 15.

In FIG. 10, the further the inflection pointer 41 of the graph 40 is moved above the straight line of the linear region, the greater will be the percentage of the linear region in the output signal of the imaging element 4. Thus, a 100% linear region will result if it is moved to the top position of the upper setting limit. In the meantime, the further the inflection pointer 41 of the graph 40 is moved below the straight line of the linear region, the greater will be the percentage of the logarithmic region in the output signal of the imaging element 4. Thus, a 100% logarithmic region will result if it is moved to the bottom position of the lower setting limit. It should be noted that there is no change in the inclination of the linear region of the graph 40 since the inflection point is controlled by the voltage value VL set on the imaging element 4 of the present embodiment.

When the position of the inflection pointer 41 of the graph 40 has been determined on the inflection point adjusting sub-screen 39 on the preview screen displayed on the monitor 11, the lin-log inflection point changing section 22 calculates the voltage value VL to be set on the imaging element 4 in order to change the inflection point according to that position.

It is also possible to arrange such a configuration that the position of the inflection pointer 41 in the graph 40 of the inflection point adjusting sub-screen 39 is associated with the voltage value VL, and a LUT is created in advance. This LUT is stored in the lin-log inflection point changing section 22 and is used to get the voltage value VL.

The lin-log inflection point changing section 22 is provided with a digital-to-analog converter 36. The voltage value VL having been calculated is converted into analog data, which is inputted into the pixels G₁₁ through Gₘₙ, whereby the inflection point of the imaging element 4 is changed.

Referring to the flow chart of FIG. 11, the following describes the outline of the operation of the imaging device 1 of the present embodiment:

When the power is turned on, the imaging mode selection screen appears on the monitor 11. The “inflection point adjustment imaging mode” is selected by operating the cross-shaped key for selection 15 and the confirmation key at the center is pressed. Then the imaging device 1 enters the inflection point adjustment imaging mode, and the system goes to the display process (Step S1). Then the inflection point adjusting sub-screen 39 appears on the preview screen of the monitor 11, as shown in FIG. 10. This inflection point adjusting sub-screen 39 represents the graph 40 showing the output signal with respect to the incident light quantity of the imaging element 4. The graph 40 indicates the inflection pointer 41 as the boundary between the linear region and logarithmic region (Step S12).

Then the user operates the cross-shaped key for selection 15 to move the inflection pointer 41 of the graph 40 above the straight line of the linear region, whereby the inflection point is determined (Step S13). In this case, the user is allowed to make fine adjustment of the inflection point by operating the cross-shaped key for selection 15.

For example, in FIG. 10, the further the inflection pointer 41 of the graph 40 is moved above the straight line, the greater will be the percentage of the linear region in the output signal of the imaging element 4. Thus, a 100% linear region will result if it is moved to the top position of the upper setting limit. In the meantime, the further the inflection pointer 41 of the graph 40 is moved below the straight line of the linear region, the greater will be the percentage of the logarithmic region in the output signal of the imaging element 4. Thus, a 100% logarithmic region will result if it is moved to the bottom position of the lower setting limit. It should be noted that there is no change in the inclination of the linear region of the graph 40 since the inflection point is controlled by the voltage value VL set on the imaging element 4 of the present embodiment.

Then the lin-log inflection point changing section 22 goes to the lin-log inflection point changing process. When the position of the inflection pointer 41 of the graph 40 has been determined on the inflection point adjusting sub-screen 39 on the preview screen displayed on the monitor 11, the lin-log inflection point changing section 22 calculates the voltage value VL to be set on the imaging element 4 in order to change the inflection point according to that position (Step S14).

The digital-to-analog converter 36 of the lin-log inflection point changing section 22 converts the calculated voltage value VL into analog data, which is inputted into the pixels G₁₁ through Gₘₙ of the imaging element 4, whereby the inflection point of the imaging element 4 is changed (Step S15).

After that, the monitor 11 displays the preview screen subsequent to change of the inflection point (Step S16). The graph 40 shows the position of the inflection pointer 41 subsequent to the change.

As described above, the user operates the cross-shaped key for selection 15 to move the inflection pointer 41 of the graph 40 on the preview screen of the monitor 11. While moving the inflection pointer 41, the user visually observes the captured image subsequent to the change of the inflection point on the preview screen, whereby verification is made to see if a desired captured image can be obtained or not (Step S17). If it has been determined that the desired captured image cannot be obtained (NO in Step S17), the system goes back to the Step 13, and the inflection pointer 41 of the graph 40 is moved, whereby a new inflection point can be determined.

If it has been verified that a desired captured image can be obtained by changing the inflection point on the preview screen of the monitor 11 (YES in Step S17), the release switch 16 is halfway pressed, and the AF operation as a preparatory operation for imaging is performed. At the same time, the AE evaluation value is calculated. If the release switch 16 is not pressed, the preview screen subsequent to change of the inflection point appears on the monitor 11. This status is kept unchanged.

When the user has pressed the release switch 16 fully, imaging operation starts. After that, the same procedure as that of the first embodiment is performed until the image data is recorded on the recording section 10.

As described above, according to the present embodiment, the user can move the inflection pointer 41 by visually observing it on the graph 40 displayed on the monitor 11. This arrangement allows the user to have a clear idea on how the inflection point is changed by his or her own operation. Especially, the user determines the position of the inflection pointer 41 on the graph 40, and hence, easily gets a clear idea on the change of the photoelectric conversion characteristics of the imaging element 4 subsequent to change of the inflection point. Further, the position of the inflection point can be fine-adjusted by the movement of the inflection pointer 41.

The graph 40 subsequent to change of the inflection point is displayed as a result of change of the inflection point by the user's operation. Accordingly, the user can determine the position of the inflection point by visually observing how the photoelectric conversion characteristics of the imaging element are changed by changing the inflection point. Further, the preview screen subsequent to a change of the inflection point is shown. This arrangement allows the user to verify how the captured image is changed by his or her own operation.

### Embodiment 3

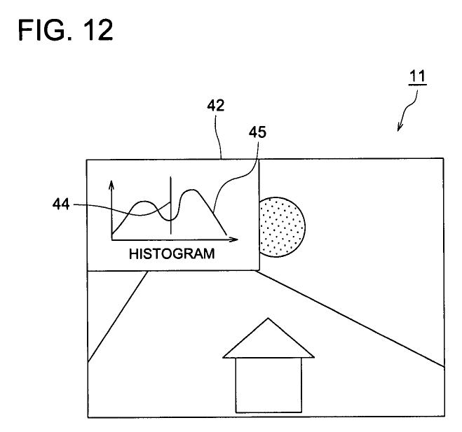

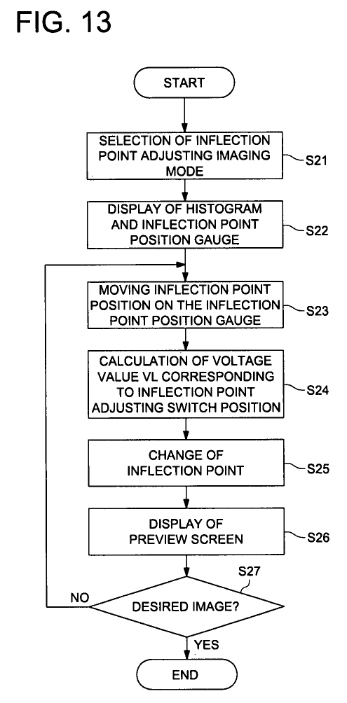

Referring to FIGS. 12 and 13, the following describes the third embodiment of the present invention: the same portions as the aforementioned first embodiment will be assigned with the same numerals of reference, and will not be described to avoid duplication. Only the arrangements different from those of the first embodiment will be discussed.

When the “inflection point adjustment imaging mode” has been selected as an imaging mode, the monitor 11 shows the inflection point adjusting sub-screen 42 on the preview screen, as shown in FIG. 12.

The inflection point adjusting sub-screen 42 shows a histogram 45 wherein the frequency of the occurrence (number of pixels) is plotted on the vertical axis with the imaging element output on the horizontal axis; and an inflection point setting line 44 as a boundary between the linear and logarithmic conversion operations.

The inflection point setting line 44 shows the current position of the inflection point as the boundary between the linear region and logarithmic region. Further, the inflection point can be changed by the movement of the inflection point setting line 44 in the lateral direction in the drawing.

In FIG. 12, the percentage of the linear region in the output signal of the imaging element 4 is increased as the inflection point setting line 44 goes to the right facing the illustrated screen. Thus, a 100% linear region will result if it is moved to the rightmost position. In the meantime, the percentage of the logarithmic region in the output signal of the imaging element 4 is increased as the inflection point setting line 44 goes to the left facing the screen. Thus, a 100% logarithmic region will result if it is moved to the left position. Due to the correspondence with the horizontal axis of the histogram 45, the right/left relationship in the correspondence between the inflection point setting line 44 and the inflection point in imaging element 4 can be reversed.

This histogram 45 reflects a change in the imaging element output signal value resulting from a change of the inflection point. When displayed in the form overlapped with the preview screen, as shown in FIG. 12, the user is allowed to adjust the inflection point by referring to the distribution of the imaging element output signal value. For example, if the inflection point is adjusted by mere visual observation of the preview screen of the monitor 11, the user will find it difficult to identify the white skip accurately and to adjust the inflection point, because of the monitor performances and ambient illumination conditions. Conversely, contrast will deteriorate if the inflection point is much lowered to ensure that the output signal of the imaging element 4 will not be saturated. To avoid this difficulty, adjustment is made by visually observing the histogram 45 in such a way that the data on the higher luminance side will be lost, whereby the optimum inflection point is set, and maneuverability is further improved.

The cross-shaped key for selection 15 of the operation section 21 of the present embodiment is designed in such a way that the position of the inflection point setting line 44 displayed on the inflection point adjusting sub-screen 42 can be moved by pressing the cross-shaped key in the “inflection point adjustment imaging mode”. Thus, when the inflection point setting line 44 is moved in the lateral direction, the position of the inflection point can be changed. In this manner, the user is allowed to make fine adjustment of the position of the inflection point by operating the cross-shaped key for selection 15.

Further, when the position of the inflection point setting line 44 has been determined on the inflection point adjusting sub-screen 42 on the preview screen displayed on the monitor 11, the lin-log inflection point changing section 22 of the present embodiment calculates the voltage value VL to be set on the imaging element 4, in order to change the inflection point in conformity to that position.

It is also possible to arrange such a configuration that the position inflection point setting line 44 is associated with the voltage value VL, and a LUT is created in advance. This LUT is stored in the lin-log inflection point changing section 22, and is used to calculate the voltage value VL.

Further, the lin-log inflection point changing section 22 has a digital-to-analog converter 36. The calculated voltage value VL is converted into the analog data, which is inputted into the pixels G₁₁ through Gₘₙ of the imaging element 4, whereby the inflection point of the imaging element 4 is changed.

Referring to the flow chart of FIG. 13, the following describes the outline of the operation of the imaging device 1 of the present embodiment:

When the power is turned on, the imaging mode selection screen appears on the monitor 11.

The “inflection point adjustment imaging mode” is selected by operating the cross-shaped key for selection 15 and the confirmation key at the center is pressed. Then the imaging device 1 enters the inflection point adjustment imaging mode, and the system goes to the display process (Step S21). Then the inflection point adjusting sub-screen 42 appears on the preview screen of the monitor 11 in an overlapped form, as shown in FIG. 12 (Step S22).

The inflection point adjusting sub-screen 42 indicates the aforementioned histogram 45 and inflection point setting line 44 showing the position of the inflection point.

Then the user operates the cross-shaped key for selection 15 to move the inflection point setting line 44 in the lateral direction, whereby the inflection point is changed (Step S23). In this case, the user is allowed to make fine adjustment of the inflection point by operating the cross-shaped key for selection 15.

In FIG. 12, the percentage of the linear region in the output signal of the imaging element 4 is increased as the inflection point setting line 44 goes to the right facing the illustrated screen. Thus, a 100% linear region will result if it is moved to the rightmost position. In the meantime, the percentage of the logarithmic region in the output signal of the imaging element 4 is increased as the inflection point setting line 44 goes to the left facing the screen. Thus, a 100% logarithmic region will result if it is moved to the left position. Due to the correspondence with the horizontal axis of the histogram 45, the right/left relationship in the correspondence between the inflection point setting line 44 and the inflection point in imaging element 4 can be reversed.

When the inflection point setting line 44 is moved, the histogram 45 gives a display by reflecting the captured image output signal value resulting from a change of the inflection point. The user makes adjustment by visually observing the histogram 45 in such a way that the data on the higher luminance side will be lost, whereby the optimum inflection point is set, and maneuverability is further improved.

Then the lin-log inflection point changing section 22 goes to the process of changing the inflection point. When the position of the inflection point setting line 44 has been determined on the inflection point adjusting sub-screen 42 on the preview screen displayed on the monitor 11, the lin-log inflection point changing section 22 calculates the voltage value VL to be set on the imaging element 4, in order to change the inflection point in conformity to that position (step S24).

The digital-to-analog converter 36 of the lin-log inflection point changing section 22 converts the calculated voltage value VL into analog data, which is inputted into the pixels G₁₁ through Gₘₙ of the imaging element 4, whereby the inflection point of the imaging element 4 is changed (Step S25).

After that, the monitor 11 displays the preview screen subsequent to change of the inflection point (Step S26). In other words, both the preview screen subsequent to change of the inflection point and histogram are displayed.

As described above, the user operates the cross-shaped key for selection 15 to move the inflection point setting line 44 on the preview screen of the monitor 11. While moving the inflection point setting line 44, the user checks if a desired captured image can be obtained or not (Step S27). In this case, the histogram 45 provides a display by reflecting a change in the imaging element output signal value resulting from the change in the inflection point. This allows the user to verify a change in the histogram 45. If it has been determined that the desired captured image cannot be obtained (NO in Step S27), the system goes back to the Step 23, and the inflection point setting line 44 is further moved, whereby a new inflection point is determined.

If it has been verified that a desired captured image can be obtained by changing the inflection point on the preview screen of the monitor 11 (YES in Step S27), the release switch 16 is halfway pressed, and the AF operation as a preparatory operation for imaging is performed. At the same time, the AE evaluation value is calculated. If the release switch 16 is not pressed, the preview screen subsequent to change of the inflection point appears on the monitor 11. This status is kept unchanged.

When the user has pressed the release switch 16 fully, imaging operation starts. After that, the same procedure as that of the first embodiment is performed until the image data is recorded on the recording section 10.

As described above, according to the present embodiment, the same advantage as that of the first embodiment can be obtained by the inflection point setting line 44. Not only that, a histogram of the imaging element output signal value subsequent to a change in the inflection point as a result of a change in the inflection point by the user's operation is shown. Thus, the user makes adjustment by visually observing the histogram 45 in such a way that the saturated data on the higher luminance side will be lost, whereby the optimum inflection point is set, and maneuverability is further improved.

As described above, the imaging device of the present invention allows the inflection point to be set to a desired level, whereby the photoelectric conversion characteristics of the imaging element is changed as desired, and a desired captured image is obtained.

In the inflection point position gauge appearing on the display section, the user is allowed to verify the position of the inflection point by his or her own operation. Further, the position of the inflection point can be fine-adjusted by the movement of the inflection point. This arrangement ensures the photoelectric conversion characteristics of the imaging element to be changed as desired, whereby a desired captured image is obtained easily.

Further, the user is allowed to determine the position of the inflection point by visually observing the change in the captured image by his or her own operation. This arrangement ensures the photoelectric conversion characteristics of the imaging element to be changed as desired, whereby a desired captured image is obtained easily.

In the graph showing the imaging element output signal appearing on the display section, the user is allowed to have a clear idea on how the inflection point is changed by visually observing the position of the inflection pointer. Further, the user determines the position of the inflection pointer on the graph, wherein the user easily gets a clear idea on the change of the photoelectric conversion characteristics of the imaging element subsequent to change of the inflection point. Moreover, the position of the inflection point can be fine-adjusted by the movement of the inflection pointer 41. Thus, the user is allowed to change the photoelectric conversion characteristics of the imaging element as desired, and to get the captured image easily.

Further, the user can determine the position of the inflection point by visually observing how the photoelectric conversion characteristics of the imaging element are changed by changing the inflection point. Moreover, the user can verify a change in the captured image by his or her own operation. This arrangement enables the user to change the photoelectric conversion characteristics of the imaging element as desired, and to get the captured image easily.

The user makes adjustment by visually observing the histogram in such a way that the saturated data on the higher luminance side will be lost, whereby the optimum inflection point is set, and maneuverability is further improved.

In the histogram showing the display section, the user easily gets a clear idea on the change of the inflection point by visually observing the position of the inflection point setting line, and easily identifies a change in the imaging element output value subsequent to the change in the inflection point. Further, the position of the inflection point can be fine-adjusted according to the movement of the inflection point setting line. Thus, the user is permitted to change the photoelectric conversion characteristics of the imaging element as desired and to get a desired captured image easily.

Further, the user can verify a change in the captured image by his or her own operation on the preview screen. This enables the user to change the photoelectric conversion characteristics of the imaging element as desired and to get a desired captured image easily.

What is claimed is:

1. An imaging device comprising:
an imaging element which comprises a plurality of pixels capable of switching between a linear conversion operation for linearly converting incident light into an electric signal and a logarithmic conversion operation for logarithmically converting the incident light into an electric signal, according to an incident light quantity;
an operation section which is operated for changing an inflection point, the inflection point is a boundary between a linear region and a logarithmic region of output signals of the imaging element; and
an inflection point changing section which changes the inflection point of the imaging element according to an operation of the operation unit.

2. The imaging device described in claim 1, further comprising a monitor which displays the inflection point position gauge provided with an inflection pointer showing a position of the inflection point,
wherein, the operation section is configured to be able to move the inflection pointer on the inflection point position gauge, and the inflection point changing section changes the inflection point in response to a position of the inflection pointer on the inflection point position gauge.

3. The imaging device described in claim 2, wherein the monitor displays the inflection point position gauge on a preview screen of a captured image, and displays the preview screen subsequent to a change of the inflection point, in response to the change of the inflection point by the inflection point changing section.

4. The imaging device described in claim 1, further comprising a monitor which displays a graph showing a relationship between an output signal and an incident light quantity to the imaging element, together with an inflection pointer showing a position of the inflection point on the graph,
wherein, the operation section is configured to be able to move the inflection pointer on the graph, and the inflection point changing section changes the inflection point in response to a position of the inflection pointer on the graph.

5. The imaging device described in claim 4, wherein the monitor displays the graph and the inflection pointer on a preview screen of a captured image, and displays the preview screen subsequent to a change of the inflection point, in response to the change of the inflection point by the inflection point changing section.

6. The imaging device described in claim 1, further comprising a monitor which displays a histogram of output signal values of the imaging element and a inflection point setting line showing the position of the inflection point on the histogram,
wherein, the operation section is configured to be able to move the inflection point setting line on the histogram, and the inflection point changing section changes the inflection point in response to a position of the inflection point setting line on the histogram.

7. The imaging device described in claim 6, wherein the monitor displays the histogram subsequent to a change of the inflection point, as well as the preview screen subsequent to the change of the inflection point.

8. The imaging device described in claim 1, wherein the inflection point changing section changes the inflection point by changing a voltage value set on the plurality of pixels of the imaging element.

9. The imaging device described in claim 1, wherein the inflection point changing section changes the inflection point by changing a voltage value set on the plurality of pixels of the imaging element.

10. The imaging device described in claim 2, wherein the inflection point changing section changes the inflection point by changing a voltage value set on the plurality of pixels of the imaging element.

11. The imaging device described in claim 3, wherein the inflection point changing section changes the inflection point by changing a voltage value set on the plurality of pixels of the imaging element.

12. The imaging device described in claim 4, wherein the inflection point changing section changes the inflection point by changing a voltage value set on the plurality of pixels of the imaging element.

13. The imaging device described in claim 5, wherein the inflection point changing section changes the inflection point by changing a voltage value set on the plurality of pixels of the imaging element.

14. The imaging device described in claim 6, wherein the inflection point changing section changes the inflection point by changing a voltage value set on the plurality of pixels of the imaging element.

15. The imaging device described in claim 7, wherein the inflection point changing section changes the inflection point by changing a voltage value set on the plurality of pixels of the imaging element.
